(19) United States
(12) Patent Application Publication
(10) Pub. No.: US 2026/0240084 A1
(43) Pub. Date: Aug. 20, 2026

(54) BOUNDARY CUTTING TOOL

(71) Applicant: Nanjing Chervon Industry Co., Ltd., Nanjing (CN)

(72) Inventors: Toshinari Yamaoka, Nanjing (CN); Hao Qu, Nanjing (CN)

(21) Appl. No.: 19/276,632

(22) Filed: Jul. 22, 2025

(30) Foreign Application Priority Data
Feb. 18, 2025 (CN) 202520264032.6

(51) Int. Cl. A01G 3/06; A01D 34/81; A01D 34/84; A01D 101/00

(52) U.S. Cl. CPC A01G 3/062; A01D 34/81; A01D 34/84; A01D 2101/00

(57) ABSTRACT

A boundary cutting tool includes a tool body. The tool body includes a motor, a cutting blade, and a guard. The cutting blade is configured to be driven by the motor to rotate about a first axis a. The guard covers part of the cutting blade. The cutting blade includes a mounting region having a mounting plane and at least one blade arm. The blade arm has a first curved section and a second curved section. The first curved section has a first line b, and the second curved section has a second line c. The first line b is not parallel to the second line c.

### RELATED APPLICATION INFORMATION

This application claims the benefit under 35 U.S.C. § 119(a) of Chinese Patent Application No. CN 202520264032.6, filed on Feb. 18, 2025, which application is incorporated herein by reference in its entirety.

### TECHNICAL FIELD

The present application relates to an electrical device and, in particular, to a boundary cutting tool.

### BACKGROUND

A boundary cutting tool is an electrical device in the related art. Common boundary cutting tools include boundary definers, lawn edgers, trenchers, and lawn edge trimmers. The boundary cutting tool is a device capable of trimming clear boundaries and distinctly separating the lawn from adjacent regions. The existing boundary cutting tool has the disadvantage of a low cutting efficiency, requiring users to spend a longer time on the cutting operation, increasing the labor intensity of users, and reducing the user experience.

This part provides background information related to the present application, and the background information is not necessarily the existing art.

### SUMMARY

A boundary cutting tool includes a tool body. The tool body includes a motor; a cutting blade configured to be driven by the motor to rotate about a first axis a for cutting; and a guard covering part of the cutting blade. The cutting blade includes a mounting region having a mounting plane. The cutting blade further includes at least one blade arm. The blade arm has a first curved section and a second curved section. The first curved section has a first line b, and the second curved section has a second line c. The first line b is not parallel to the second line c.

In some examples, the first curved section is adjacent to the mounting region, and the second line c is away from the mounting region.

In some examples, the first line b is basically perpendicular to a first region edge line d of the mounting region.

In some examples, the included angle D between the second line c and a second region edge line e of the blade arm is greater than or equal to 70° and less than 90°.

In some examples, the overall width of the cutting blade is basically uniform.

In some examples, the overall width L of the cutting blade is basically 50 mm.

In some examples, a first extension section having a first extension plane is disposed between the first curved section and the second curved section, and the included angle A between the first extension plane and the mounting plane is greater than 90° and less than 110°.

In some examples, the other end of the second curved section is adjacent to a second extension section having a second extension plane; the end of the second extension section is configured to be a free end; the free end has a first side and a second side that is longer than the first side; the included angle B between the first side and a side of the second extension section is basically set to 115°; and the included angle C between the second side and a side of the second extension section is basically set to 100°.

In some examples, the thickness of the cutting blade is basically 5 mm.

In some examples, the cutting blade is configured to be an integrally formed metal part.

A boundary cutting tool includes a tool body. The tool body includes a motor configured to be rotatable about a first axis a to generate a driving force; a cutting blade configured to be driven by the motor to rotate about the first axis a for cutting; and a guard covering part of the cutting blade. The cutting blade includes a mounting region, where a mounting hole is formed in the mounting region so that the cutting blade is mounted to an output shaft of the motor. The cutting blade further includes at least one blade arm. The blade arm has a free end away from the mounting region. The top end of the free end has a first side and a second side that is longer than the first side. The first side is basically perpendicular to a first region edge line d of the mounting region.

In some examples, the blade arm has a first curved section and a second curved section, the first curved section has a first line b, and the second curved section has a second line c, where the first line b is not parallel to the second line c.

In some examples, the first curved section is adjacent to the mounting region, and the second line c is away from the mounting region.

In some examples, the first line b is basically perpendicular to the first region edge line d of the mounting region.

In some examples, the included angle D between the second line c and a second region edge line e of the blade arm is greater than or equal to 70° and less than 90°.

In some examples, a first extension section having a first extension plane is disposed between the first curved section and the second curved section, the mounting region has a mounting plane, and the included angle A between the first extension plane and the mounting plane is greater than 90° and less than 110°.

In some examples, the other end of the second curved section is adjacent to a second extension section having a second extension plane; the end of the second extension section is configured to be the free end; the free end has the first side and the second side that is longer than the first side; the included angle B between the first side and a side of the second extension section is basically set to 115°; and the included angle C between the second side and a side of the second extension section is basically set to 100°.

In some examples, the overall width of the cutting blade is basically uniform.

In some examples, the overall width L of the cutting blade is basically 50 mm.

In some examples, the thickness of the cutting blade is basically 5 mm.

In some examples, the cutting blade is configured to be an integrally formed metal part.

A boundary cutting tool includes a tool body. The tool body includes a motor configured to be rotatable about a first axis a to generate a driving force; a cutting blade configured to be driven by the motor to rotate about the first axis a to cut the ground; and a guard covering part of the cutting blade. The cutting blade includes a mounting region having a mounting plane. The cutting blade further includes at least one blade arm. The blade arm has a free end away from the mounting region, and a cutting edge is formed at the free end.

In some examples, the mounting region has a mounting surface facing the mounting position on the tool body; the blade arm has a cutting surface on the same side as the mounting surface; and at least part of the cutting surface forms the cutting edge.

In some examples, the free end includes a first cutting edge and a second cutting edge, the first cutting edge includes at least a cutting edge that first cuts the ground along the rotational cutting direction, the second cutting edge includes a cutting edge that last cuts the ground along the rotational cutting direction, and the cutting edge is formed from at least part of the first cutting edge toward the cutting surface.

In some examples, the second cutting edge is basically perpendicular to the first region edge line d of the mounting region.

In some examples, the cutting edge with a width of at least 1 mm is formed at the first cutting edge.

In some examples, the blade angle of the cutting edge is greater than or equal to 30° and less than or equal to 80°.

The present application has the benefits below.

The boundary cutting tool provided in the present application includes a tool body. The tool body includes a motor, a cutting blade, and a guard. The cutting blade is configured to be driven by the motor to rotate about a first axis a for cutting. The guard covers part of the cutting blade. The cutting blade includes a mounting region and at least one blade arm. The mounting region has a mounting plane. The blade arm has a first curved section and a second curved section. The first curved section has a first line b, and the second curved section has a second line c. The first line b is not parallel to the second line c. In the boundary cutting tool, the blade arm has the first curved section and the second curved section, and the first line b of the first curved section is not parallel to the second line c of the second curved section so that the cutting efficiency of the boundary cutting tool can be improved, the working duration of the user can be reduced, the workload on the user can be reduced, and the user experience can be improved.

### BRIEF DESCRIPTION OF THE DRAWINGS

FIG. 1 is a schematic view of some structures of a boundary cutting tool.

FIG. 2 is a schematic view of the structures shown in FIG. 1 from another perspective.

FIG. 3 is a schematic view of a cutting blade from a first perspective.

FIG. 4 is a schematic view of a cutting blade from a second perspective.

FIG. 5 is a schematic view of a cutting blade from a third perspective.

FIG. 6 is a schematic view of a cutting blade from a fourth perspective.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a ...” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblie, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

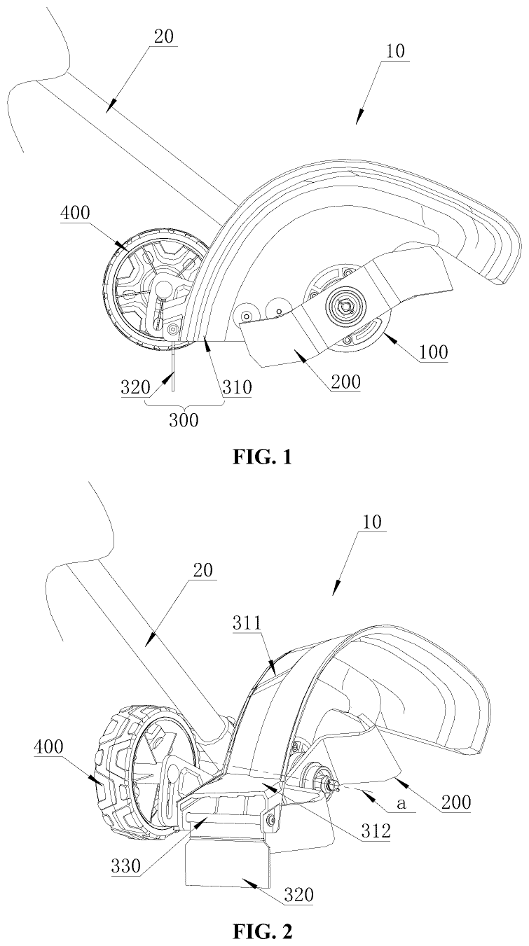

The present application discloses a boundary cutting tool which can be used for trimming a lawn to form a clear boundary between the lawn surface and an adjacent region. As shown in FIGS. 1 and 2, the boundary cutting tool includes a tool body 10, a guide tube 20, and a handle (not shown in the figure). The tool body 10 is connected to the bottom end of the guide tube 20. The handle is disposed on the guide tube 20 and is adjacent to the top end of the guide tube 20 or directly disposed at the top end of the guide tube 20. The user can operate the boundary cutting tool by holding the handle. A grip (not shown in the figure) is further provided at the handle or near the handle so that the user can operate the boundary cutting tool more stably by holding the handle with one hand and holding the grip with the other hand. An accelerator lever (not shown in the figure) and an accelerator lock lever (not shown in the figure) are further provided at the handle.

As shown in FIGS. 1 and 2, the tool body 10 includes a motor 100, a cutting blade 200, and a guard 300. The motor 100 is configured to be rotatable about a first axis a to generate a driving force, the cutting blade 200 is configured to be driven by the motor 100 to rotate about the first axis a for cutting, and the guard 300 covers part of the cutting blade 200. The motor 100 may be an internal combustion engine or an electric motor.

In some examples, an output shaft of the motor 100 is directly connected to the cutting blade 200. In some other examples, to move the center of gravity of the boundary cutting tool upward to reduce the operation difficulty for the user, a motor housing is provided at the top of the guide tube 20, and the motor 100 is mounted in the motor housing. A centrifugal clutch (not shown in the figure) and a starting device (not shown in the figure) are further mounted in the motor housing, and a drive shaft (not shown in the figure) is further disposed in the guide tube 20. The motor 100 is drivingly connected to an end of the drive shaft via the centrifugal clutch, and the other end of the drive shaft is drivingly connected to the cutting blade 200 so that the driving force of the motor 100 can be transmitted to the cutting blade 200. The starting device may be a pull cord starter.

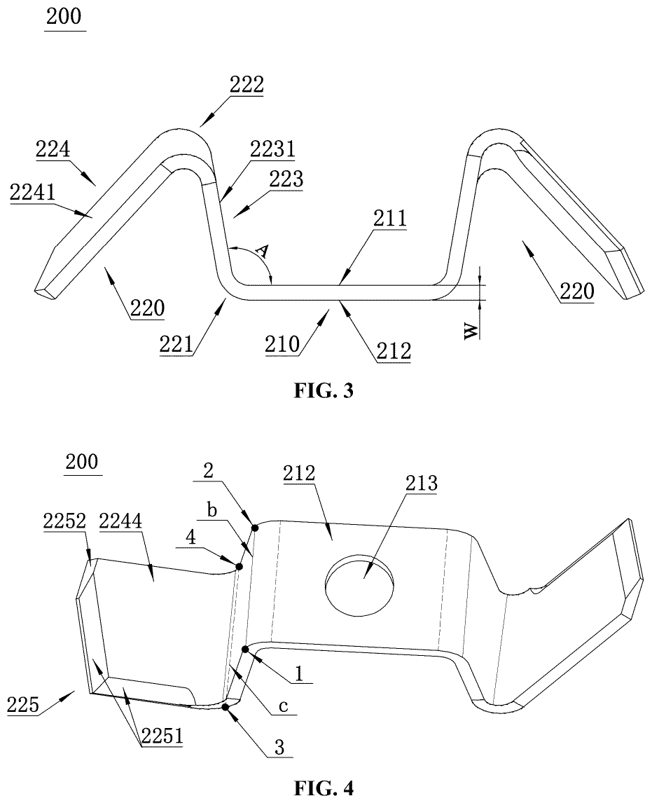

As shown in FIGS. 3 to 6, the cutting blade 200 includes a mounting region 210 and at least one blade arm 220, and the blade arm 220 has a free end away from the mounting region 210 and a connecting end adjacent to the mounting region 210. The mounting region 210 is a region on the cutting blade 200 where the cutting blade 200 is drivingly connected to the motor 100. The mounting region 210 has a mounting plane 211, and a mounting hole 213 is formed in the mounting region 210 so that the cutting blade 200 could be fixed to a motor shaft through the mounting hole 213. In an example, the cutting blade 200 may be directly mounted to the output shaft of the motor 100 through the mounting hole 213. In another example, the other end of the drive shaft is drivingly connected to the cutting blade 200 through a gear assembly, and the cutting blade 200 is mounted to a gear shaft of the gear assembly through the mounting hole 213.

In some examples, the cutting blade 200 has two blade arms 220 that are disposed on two opposite sides of the mounting region 210 and are substantially in a “W” shape. In another example, one blade arm 220 is provided, and the blade arm 220 is disposed on one side of the mounting region 210 and is substantially in a “V” shape.

In some examples, the blade arm 220 has a first curved section 221 and a second curved section 222, the first curved section 221 may be independent of the connecting end or included in the connecting end, the first curved section 221 has a first line b, the second curved section 222 has a second line c, and the first line b is not parallel to the second line c. Compared with the cutting blade in the existing art, in the boundary cutting tool disclosed in the present application, the blade arm 220 has the first curved section 221 and the second curved section 222, and the first line b of the first curved section 221 is not parallel to the second line c of the second curved section 222 so that the cutting efficiency of the boundary cutting tool can be improved, the working duration of the user can be reduced, the workload on the user can be reduced, and the user experience can be improved. It is to be noted that the first line b and the second line c are both straight lines. The first line b is a geometric line for representing the bending position and bending shape of the first curved section 221, and the second line c is a geometric line for representing the bending position and bending shape of the second curved section 222. Alternatively, it is to be understood that the first line b represents a straight line formed by the vertex 1 and vertex 2 of the arc surface of the first curved section 221, and the second line c represents a straight line formed by the vertex 3 and vertex 4 of the arc surface of the second curved section 222.

In some examples, the first curved section 221 is adjacent to the mounting region 210, and the second line c is away from the mounting region 210. Or say, the distance between the second line c and a geometric center 214 of the mounting region 210 is greater than the distance between the first line b and the geometric center 214 of the mounting region 210.

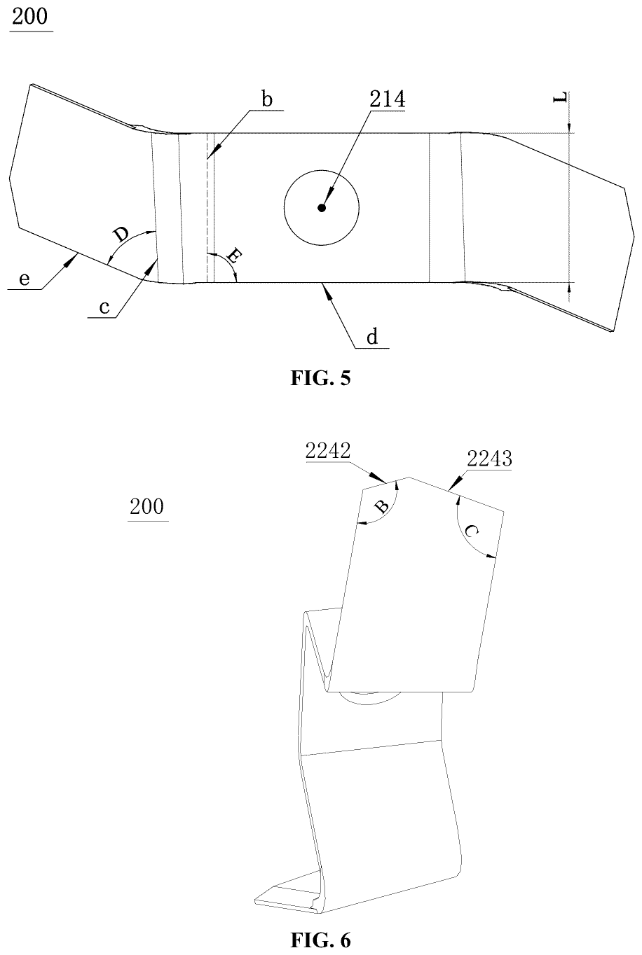

In some examples, the first line b is basically perpendicular to the first region edge line d of the mounting region 210. That is, as shown in FIG. 5, the included angle E between the first line b and the first region edge line d of the mounting region 210 is basically 90°, for example, 85°, 90°, 93°, or 95°.

In some examples, with continued reference to FIG. 5, the included angle D between the second line c and the second region edge line e of the blade arm 220 is greater than or equal to 70° and less than 90°. In a specific example, the included angle D between the second line c and the second region edge line e of the blade arm 220 is 70°, 71°, 72°, 73°, 74°, 75°, 76°, 77°, 78°, 79°, 80°, 81°, 82°, 83°, 84°, 85°, 86°, 87°, 88°, 89°, or 90°. Of course, in other examples, the included angle D between the second line c and the second region edge line e of the blade arm 220 may be set to other values within the range of 70° to 90° according to requirements.

In some examples, the overall width of the cutting blade 200 is basically uniform. In a specific example, the overall width L (see FIG. 5) of the cutting blade 200 is basically 50 mm. Of course, in other examples, the overall width of the cutting blade 200 may be adjusted as required.

In some examples, the blade arm 220 further has a first extension section 223, the first extension section 223 is located between the first curved section 221 and the second curved section 222, and the first extension section 223 has a first extension plane 2231.

With continued reference to FIG. 3, the included angle A between the first extension plane 2231 and the mounting plane 211 is greater than 90° and less than 110°. In a specific example, the included angle A between the first extension plane 2231 and the mounting plane 211 is 91°, 92°, 93°, 94°, 95°, 96°, 97°, 98°, 99°, 100°, 101°, 102°, 103°, 104°, 105°, 106°, 107°, 108°, 109°, or 110°. Of course, in other examples, the included angle A between the first extension plane 2231 and the mounting plane 211 may be set to other values within the range of 90° to 110° according to requirements.

In some examples, the blade arm 220 has a second extension section 224, the second extension section 224 is adjacent to the second curved section 222 and located at an end of the second curved section 222 away from the first extension section 223, and the second extension section 224 has a second extension plane 2241.

With continued reference to FIG. 6, the end of the second extension section 224 is configured to be a free end, and the free end has a first side 2242 and a second side 2243 that is longer than the first side 2242. In an example, the included angle B between the first side 2242 and the side of the second extension section 224 is basically set to 115°, and the included angle C between the second side 2243 and the side of the second extension section 224 is basically set to 100°. Of course, in other examples, the included angle B between the first side 2242 and the side of the second extension section 224 may be adjusted as required, and the included angle C between the second side 2243 and the side of the second extension section 224 may also be adjusted as required.

Further, the first side 2242 is basically perpendicular to the first region edge line d of the mounting region 210. That is to say, the included angle between the straight line where the first side 2242 is located and the straight line where the first region edge line d of the mounting region 210 is located is 90°.

In some examples, with continued reference to FIG. 4, a cutting edge 225 is formed at the free end. In a specific example, the mounting region 210 has a mounting surface 212 facing the mounting position on the tool body 10, and the boundary of the mounting region 210 is the boundary of the mounting surface 212 as shown in the area of the dotted line in FIG. 4. The blade arm 220 has a cutting surface 2244 on the same side as the mounting surface 212; and at least part of the cutting surface 2244 forms the cutting edge 225.

In some examples, the free end includes a first cutting edge 2251 and a second cutting edge 2252, the first cutting edge 2251 includes at least a cutting edge that first cuts the ground along the rotational cutting direction, and the second cutting edge 2252 includes a cutting edge that last cuts the ground along the rotational cutting direction. The cutting edge 225 is formed from at least part of the first cutting edge 2251 toward the cutting surface 2244. That is to say, the first cutting edge 2251 is a cutting edge that is in contact with the ground in the early stage (which may include the first contact and the subsequent contact) in the rotation direction of the cutting blade 200 and is capable of cutting the ground; and the second cutting edge 2252 is a cutting edge that is in contact with the ground in the later stage (that is, the last stage) in the rotation direction of the blade and forms a vertical cutting line.

In a specific example, with continued reference to FIG. 4, two first cutting edges 2251 are provided, an included angle is formed between the two first cutting edges 2251, one first cutting edge 2251 is in contact with the ground firstly, and the other first cutting edge 2251 is in contact with the ground subsequently.

In some examples, the second cutting edge 2252 is basically perpendicular to the first region edge line d of the mounting region 210. In this manner, the second cutting edge 2252 can form a vertical surface contact with the ground, which is conducive to reducing wear. The vertical surface contact may be understood as below. When the boundary cutting tool is started to operate, the corner of the two first cutting edges 2251 is in contact with the ground firstly. After the corner cuts the ground, as the cutting blade 200 continues rotating, the angle between the second cutting edge 2252 and the ground is basically 90°, and the second cutting edge 2252 is basically perpendicular to the ground, forming a vertical surface contact.

In some examples, the cutting edge 225 with a width of at least 1 mm is formed at the first cutting edge 2251. In some examples, the cutting edge 225 with a width of at least 1.5 mm is formed at the first cutting edge 2251. In some examples, the cutting edge 225 with a width of at least 2 mm is formed at the first cutting edge 2251. For the substantially “W”-shaped cutting blade 200, the cutting edge 225 is formed at the first cutting edge 2251, thereby facilitating the formation of a cut in the ground when the cutting blade 200 rotates to cut the ground.

In some examples, the blade angle of the cutting edge 225 is greater than or equal to 30° and less than or equal to 80°. In some examples, the blade angle of the cutting edge 225 is greater than or equal to 30° and less than or equal to 60°. In some examples, the blade angle of the cutting edge 225 is greater than or equal to 60° and less than or equal to 80°.

In a specific example, the blade angle of the cutting edge 225 is 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, or 80°. Of course, in other examples, the blade angle of the cutting edge 225 may be other values within the range of 30° to 80°.

In some examples, the thickness W (see FIG. 3) of the cutting blade 200 is basically uniform. In a specific example, the thickness W of the cutting blade 200 is basically 5 mm. Of course, in other examples, the thickness W of the cutting blade 200 may be set to other values according to requirements.

In a specific example, the free end of the cutting blade 200 is sharpened to form the cutting edge 225, the thickness of the cutting blade 200 is about 5 mm, the cutting edge 225 with a width of about 3.5 mm is formed through sharpening in the thickness direction, and the angle of inclination of the cutting edge (that is, the blade angle) is basically 60°. In addition to forming the cutting edge 225 with a width of about 3.5 mm through sharpening, a flat surface with a width of about 1.5 mm is designed, and this flat surface is basically perpendicular to the cutting surface 2244.

In some examples, the cutting blade 200 is configured to be an integrally formed metal part. In some examples, the cutting blade 200 is made of a single plate blank, and the plate blank is machined so that the cutting blade 200 is formed into an approximately W-shaped design with two blade arms 220 or is formed into an approximately V-shaped design with one blade arm 220.

The guard 300 is used for protecting the user from the cutting blade 200. With continued reference to FIGS. 1 and 2, the guard 300 includes a guard body 310 and a protective rubber 320. The guard body 310 forms an accommodation space for accommodating part of the cutting blade 200. The protective rubber 320 is disposed at an end of the guard body 310 facing the user and is used for preventing debris generated by the cutting blade 200 during rotation and cutting from flying toward the user, thereby protecting the user.

In some examples, with continued reference to FIG. 2, the protective rubber 320 is a 9-shaped rubber having a first assembly hole, the guard body 310 is provided with a second assembly hole, and a bolt 330 passes through the first assembly hole and the second assembly hole 213, thereby fixing the 9-shaped rubber to the guard body 310. In some examples, a set of self-tapping screws may be fastened to second mounting holes 213 on two sides to mount the protective rubber 320 on a fender, and the fender is configured to be a component extending from the rear side of the guard body 310 to prevent mud from being thrown backward.

In some examples, with continued reference to FIG. 2, a protruding structure 312 is formed on the rear side of the guard body 310, the protruding structure 312 is integrally formed with a body structure 311 of the guard body 310, and the protruding structure 312 is mainly used for mounting the protective rubber 320 to prevent the protective rubber 320 from being cut off when the cutting blade 200 rotates.

With continued reference to FIGS. 1 and 2, the boundary cutting tool further includes a traveling wheel 400 rotatably mounted on the guard body 310, and the traveling wheel 400 can roll on the ground. By providing the traveling wheel 400, the traveling difficulty of the boundary cutting tool can be reduced and the traveling flexibility can be improved.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A boundary cutting tool, comprising:
a motor;
a cutting blade, configured to be driven by the motor to rotate about a first axis for cutting, comprising a planar mounting region and at least one blade arm having a first curved section and a second curved section, the first curved section has a first line b, the second curved section has a second line c, and the first line b is not parallel to the second line c; and
a guard covering at least part of the cutting blade.

2. The boundary cutting tool of claim 1, wherein the first curved section is adjacent to the mounting region, and a distance between the second line c and a geometric center of the mounting region is larger than a distance between the first line b and the geometric center mounting region.

3. The boundary cutting tool of claim 1, wherein the first line b is basically perpendicular to a first region edge line d of the mounting region.

4. The boundary cutting tool of claim 1, wherein an included angle D between the second line c and a second region edge line e of the blade arm is greater than or equal to 70° and less than 90°.

5. The boundary cutting tool of claim 1, wherein an overall width of the cutting blade is basically uniform.

6. The boundary cutting tool of claim 1, wherein an overall width of the cutting blade is basically 50 mm.

7. The boundary cutting tool of claim 1, wherein the cutting blade further has a planar first extension section formed between the first curved section and the second curved section, and an included angle A between the first extension section and the mounting section is greater than 90° and less than 110°.

8. The boundary cutting tool of claim 7, wherein the cutting blade further has a planar second extension section adjacent to another end of the second curved section, an end of the second extension section is configured to be a free end, the free end has a first side and a second side that is longer than the first side, an included angle B between the first side and a side of the second extension section is basically set to 115°, and an included angle C between the second side and a side of the second extension section is basically set to 100°.

9. The boundary cutting tool of claim 1, wherein a thickness of the cutting blade is basically 5 mm.

10. The boundary cutting tool of claim 1, wherein the cutting blade is configured to be an integrally formed metal part.

11. A boundary cutting tool, comprising:
a motor having an output shaft configured to be rotatable about a first axis to generate a driving force;
a cutting blade, configured to be driven by the motor to rotate about the first axis for cutting, comprising a mounting region having a mounting hole so that the cutting blade is mountable to the output shaft of the motor and at least one blade arm having a free end away from the mounting region where a top end of the free end has a first side and a second side longer than the first side and the first side is basically perpendicular to a first region edge line of the mounting region; and
a guard covering at least part of the cutting blade.

12. The boundary cutting tool of claim 11, wherein the blade arm has a first curved section and a second curved section, the first curved section has a first line b, the second curved section has a second line c, and the first line b is not parallel to the second line c.

13. The boundary cutting tool of claim 12, wherein the first curved section is adjacent to the mounting region, and the second line c is away from the mounting region.

14. The boundary cutting tool of claim 12, wherein the first line b is basically perpendicular to a first region edge line d of the mounting region.

15. The boundary cutting tool of claim 12, wherein an included angle D between the second line c and a second region edge line e of the blade arm is greater than or equal to 70° and less than 90°.

16. The boundary cutting tool of claim 12, wherein the cutting blade further comprises a planar first extension section disposed between the first curved section and the second curved section, the mounting region is planar, and an included angle A between the first extension section and the mounting region is greater than 90° and less than 110°.

17. The boundary cutting tool of claim 16, wherein the cutting blade further comprises a planar second section adjacent to another end of the second curved section, an end of the second extension section is the free end, an included angle B between the first side and a side of the second extension section is basically set to 115°, and an included angle C between the second side and a side of the second extension section is basically set to 100°.

18. The boundary cutting tool of claim 11, wherein an overall width of the cutting blade is basically uniform.

19. The boundary cutting tool of claim 11, wherein an overall width of the cutting blade is basically 50 mm.

20. A boundary cutting tool, comprising:
a motor;
a cutting blade, configured to be driven by the motor to rotate about a first axis for cutting, comprising a planar mounting region and at least one blade arm having a free end away from the mounting region where a cutting edge is formed at the free end; and
a guard covering at least part of the cutting blade.
